(19) United States
(12) Patent Application Publication
(10) Pub. No.: US 2010/0245248 A1
(43) Pub. Date: Sep. 30, 2010

(54) MOUSE

(75) Inventor: Shao-Lun Hsiao, Taoyuan City (TW)

Correspondence Address: QUINTERO LAW OFFICE, PC, 615 Hampton Dr, Suite A202, Venice, CA, 90291, US

(73) Assignee: DARFON ELECTRONICS CORP., TAOYUAN (TW)

(21) Appl. No.: 12/732,066

(22) Filed: Mar. 25, 2010

(30) Foreign Application Priority Data
Mar. 31, 2009 (TW) 98205096

(51) Int. Cl. G06F 3/033

(52) U.S. Cl. 345/163

(57) ABSTRACT

A mouse includes an upper housing, a lower housing and a circuit board. The upper housing includes a first connecting portion, and the lower housing includes a second connecting portion and a blocking wall. The circuit board is installed between the upper housing and the lower housing. The blocking wall covers a part of the circuit board. The first connecting portion is engaged with the second connecting portion to connect the upper housing with the lower housing.

### CROSS REFERENCE TO RELATED APPLICATIONS

This Application claims priority of Taiwan Patent Application No. 98205096, filed on Mar. 31, 2009, the entirety of which is incorporated by reference herein.

### BACKGROUND OF THE INVENTION

1. Field of the Invention

The present invention relates to a mouse, and more particularly, to a mouse with the simplified structure.

2. Description of the Related Art

FIG. 1 is an exploded view of a conventional mouse. Referring to FIG. 1, the conventional mouse 10 includes an upper housing 11, a lower housing 12, a connecting assembly 13 and a circuit board 14. The circuit board 14 is installed on the lower housing 12. The connecting assembly 13 covers and connects to the circuit board 14. The upper housing 11 covers the connecting assembly 13 and then connects to the lower housing 12. The connecting assembly 13 includes a blocking wall 131. The blocking wall 131 partially covers the circuit board 14 for shielding, to avoid electromagnetic interference. Thus, the mouse 10 is not interfered with when operating.

Accordingly, the conventional mouse 10 must include an additional connecting assembly 13. The connecting assembly 13 connects the upper housing 11 with the lower housing 12, and provides shielding for the circuit board 14 on the lower housing 12. However, the conventional mouse 10 includes many components. Thus, assembly of the conventional mouse 10 is time-consuming, and the conventional mouse 10 is costly.

### BRIEF SUMMARY OF THE INVENTION

The present invention provides a mouse. The mouse includes an upper housing, a lower housing and a circuit board. The upper housing includes a first connecting portion. The lower housing includes a second connecting portion and a blocking wall. The circuit board is disposed between the upper housing and the lower housing. The blocking wall covers a part of the circuit board. The first connecting portion is engaged with the second connecting portion to connect the upper housing with the lower housing.

Note that the mouse further comprises a wheel, and the upper housing further comprises a wheel container. The wheel is disposed on the circuit board and protrudes from the wheel container.

Note that the blocking wall comprises a hole, and the wheel is disposed in the hole.

Note that the upper housing further comprises a side wall and an upper surface, and the side wall extends from the edge of the upper surface to the lower housing.

Note that the upper housing further comprises a first groove, a second groove and a wheel container, the first groove is disposed on the edge of the upper surface, the second groove intersects with the wheel container to divide the upper surface into a first pressing portion and a second pressing portion, and the first pressing portion is disposed adjacent to the second pressing portion.

Note that the first groove is U-shaped.

Note that the mouse further comprises a power line, and the power line is electrically connected to the circuit board and protrudes from the upper housing and the lower housing.

Note that the mouse further comprises a fixing element, the upper housing further comprises a first fixing hole, the circuit board comprises a second fixing hole, the lower housing further comprises a third fixing hole, and the fixing element passes through the first fixing hole, the second fixing hole and the third fixing hole to fix the upper housing, the circuit board and the lower housing, together.

Note that the first connecting portion is L-shaped.

### BRIEF DESCRIPTION OF THE DRAWINGS

The present invention can be more fully understood by reading the subsequent detailed description and examples with references made to the accompanying drawings, wherein:

FIG. 1 is an exploded view of a conventional mouse;

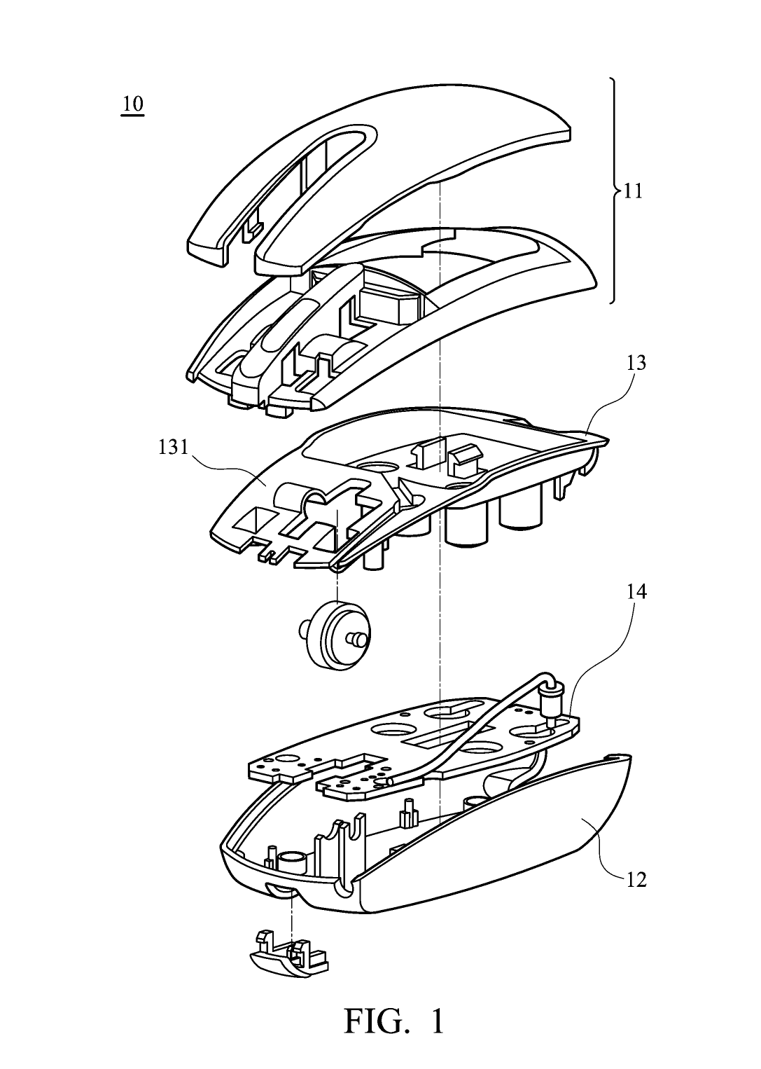

FIG. 2 is a vertical view of a mouse of the invention;

FIG. 3 is a lateral view of the mouse of the invention; and

FIG. 4 is an exploded view of the mouse of the invention.

### DETAILED DESCRIPTION OF THE INVENTION

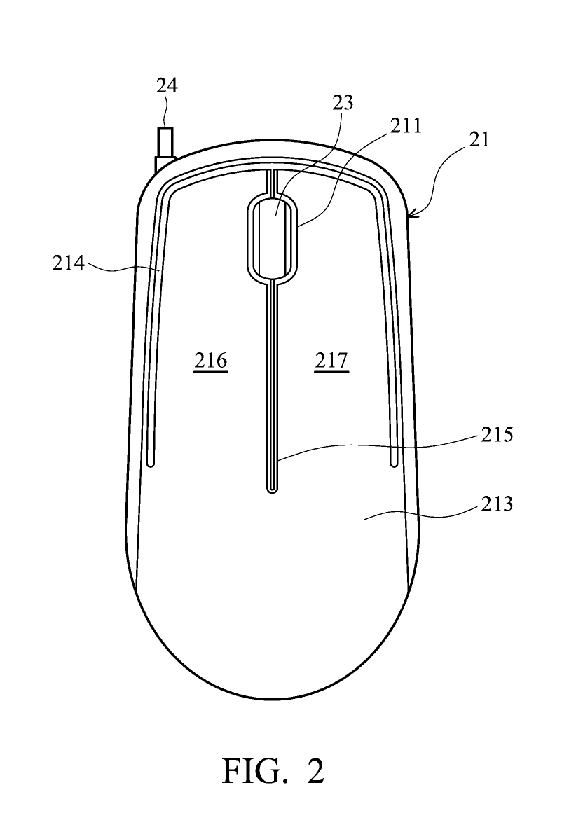

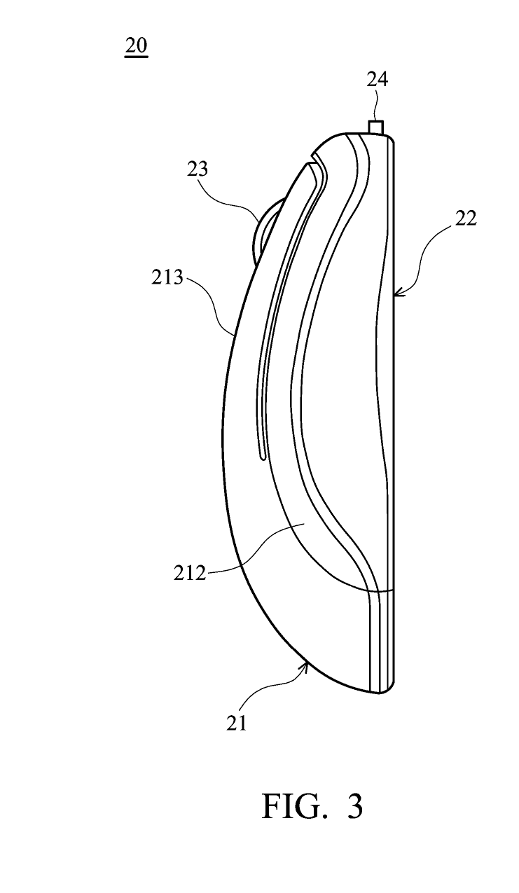

FIG. 2 is a vertical view of a mouse of the invention. FIG. 3 is a lateral view of the mouse of the invention.

Referring to FIGS. 2 and 3, a mouse 20 of the invention comprises an upper housing 21, a lower housing 22, a wheel 23. The upper housing 21 comprises a wheel container 211, a side wall 212, an upper surface 213, a first groove 214 and a second groove 215. The wheel container 211 is disposed on the upper surface 213. The wheel 23 protrudes from the wheel container 211 as a controlling key. The side wall 212 extends from the edge of the upper surface 213 to the lower housing 22 to cover the side of the mouse 20 and connect to the lower housing 22. The first groove 214 is disposed on the edge of the upper surface 213. The second groove 215 intersects with the wheel container 211 to divide the upper surface 213 into a first pressing portion 216 and a second pressing portion 217.

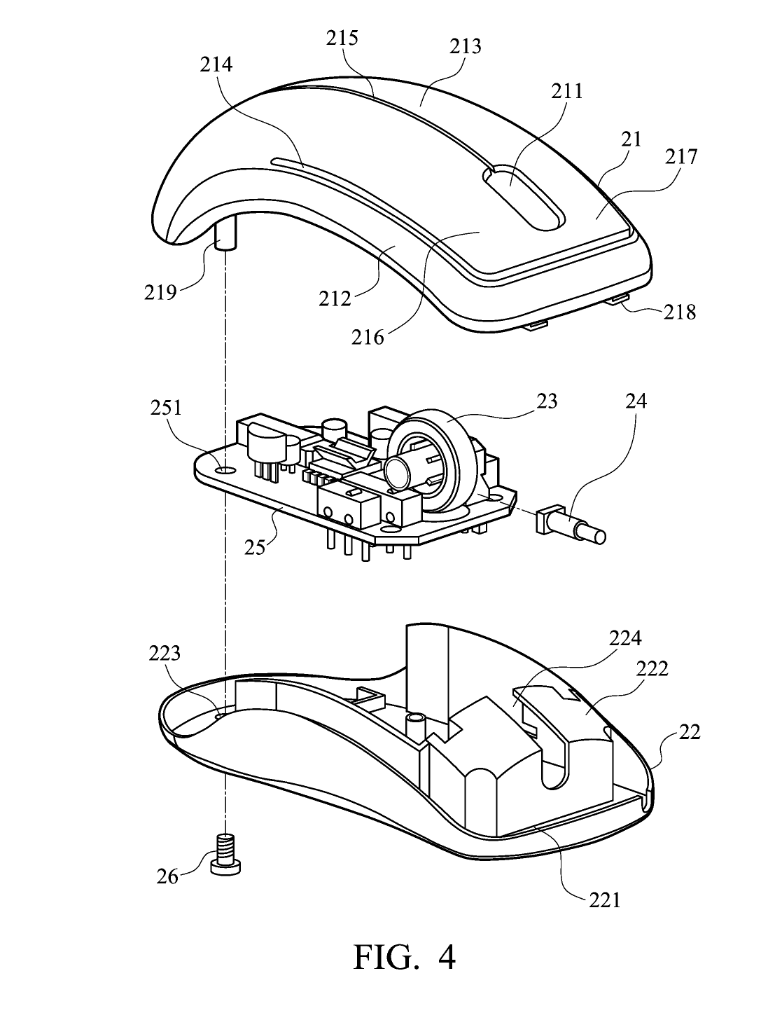

Note that if the mouse 20 is a wired mouse, the mouse 20 further comprises a power line 24. The power line 24 is disposed on the front end of the mouse 20 and is connected to the lower housing to receive or transmit signals. The power line 24 is electrically connected to the circuit board 25 (refer to FIG. 4). The power line 24 protrudes from the upper housing 21 and the lower housing 22 to connect to other electric devices (not shown).

Note that the first pressing portion 216 is disposed adjacent to the second pressing portion 217 as a key-in element of the mouse 20. The first groove 214 and the second groove 215 provide a margin of deformation for the first pressing portion 216 and the second pressing portion 217 so that the first pressing portion 216 and the second pressing portion 217 may be pressed. The side wall 212 extends from the edge of the upper surface 213 to the lower housing to increase structural strength of the upper housing 21, such that the first groove 214 and the second groove 215 do not damage the structural strength of the upper housing 21. Moreover, in this embodiment, the first groove 214 is U-shaped.

FIG. 4 is an exploded view of the mouse of the invention.

Referring to FIG. 4, the mouse 20 comprises a circuit board 25. The circuit board 25 is disposed between the upper housing 21 and the lower housing 22. The upper housing 21 further comprises a first connecting portion 218 and a first fixing hole 219. The circuit board 25 comprises a second fixing hole 251. The lower housing 22 comprises a second connecting portion 221, a blocking wall 222 and a third fixing hole 223. The second connecting portion 221 is disposed corresponding to the first connecting portion 218 and engaged with the first connecting portion 218 to connect the upper housing 21 to the lower housing 22. In this embodiment, the first connecting portion 218 is L-shaped. The second connecting portion 221 is a groove which engages with the first connecting portion 218 to connect the upper housing 21 to the lower housing 22. The first fixing hole 219, the second fixing hole 251 and the third fixing hole 223 are correspondingly disposed thereon?. The mouse 20 further comprises a fixing element 26 to pass through the first fixing hole 219, the second fixing hole 251 and the third fixing hole 223 to fix the upper housing 21, the circuit board 25 and the lower housing 22, together.

The blocking wall 25 partially covers the circuit board 25 for shielding from electromagnetic interference. Thus, the mouse 10 is not interfered with when operating. In this embodiment, the blocking wall 222 covers the front portion of the circuit board 25.

Note that the wheel is disposed on the circuit board 25 and is electrically connected to the circuit board 25. The blocking wall 222 comprises a hole 224 to contain the wheel 23. The wheel 23 protrudes from the hole 224.

In summary, the mouse 20 of the invention has a simplified structure. The mouse 20 only utilizes two parts, an upper housing 21 and a lower housing 22, for assembly and the circuit board 25 is properly shielded. Compared with the conventional mouse 10, the structure of the mouse 20 of the invention does not need a connecting assembly 13 to connect the upper housing 11 to the lower housing 12 and for shielding. Thus, assembling the mouse 20 of the invention is quick, decreasing manufacturing costs.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A mouse, comprising:
an upper housing, comprising a first connecting portion;
a lower housing, comprising a second connecting portion and a blocking wall; and
a circuit board, disposed between the upper housing and the lower housing, wherein the blocking wall covers a part of the circuit board;
wherein the first connecting portion is engaged with the second connecting portion to connect the upper housing with the lower housing.

2. The mouse as claimed in claim 1, further comprising a wheel, the upper housing further comprising a wheel container, wherein the wheel is disposed on the circuit board and protrudes from the wheel container.

3. The mouse as claimed in claim 2, wherein the blocking wall comprises a hole, and the wheel is disposed in the hole.

4. The mouse as claimed in claim 1, wherein the upper housing further comprises a side wall and an upper surface, and the side wall extends from the edge of the upper surface to the lower housing.

5. The mouse as claimed in claim 4, wherein the upper housing further comprises a first groove, a second groove and a wheel container, the first groove is disposed on the edge of the upper surface, the second groove intersects with the wheel container to divide the upper surface into a first pressing portion and a second pressing portion, and the first pressing portion is disposed adjacent to the second pressing portion.

6. The mouse as claimed in claim 5, wherein the first groove is U-shaped.

7. The mouse as claimed in claim 1, further comprising a power line, wherein the power line is electrically connected to the circuit board and protrudes from the upper housing and the lower housing.

8. The mouse as claimed in claim 1, further comprising a fixing element, wherein the upper housing further comprises a first fixing hole, the circuit board comprises a second fixing hole, and the lower housing further comprises a third fixing hole, and the fixing element passes through the first fixing hole, the second fixing hole and the third fixing hole to fix the upper housing, the circuit board and the lower housing, together.

9. The mouse as claimed in claim 1, wherein the first connecting portion is L-shaped.
